(19) United States
(12) Patent Application Publication
(10) Pub. No.: US 2013/0082422 A1
(43) Pub. Date: Apr. 4, 2013

(54) METHOD OF MAKING A LAMINATED MOLDED BODY

(71) Applicants: Herbert BADER, (US); Ralf NIEPELT, GRONAU (DE)

(72) Inventors: Herbert BADER, (US); Ralf NIEPELT, GRONAU (DE)

(21) Appl. No.: 13/630,609

(22) Filed: Sep. 28, 2012

(30) Foreign Application Priority Data
Sep. 30, 2011 (DE) 102011054121.7

(51) Int. Cl. B29C 44/06

(52) U.S. Cl. CPC B29C 44/06
USPC 264/415; 264/45.4

(57) ABSTRACT

A molded article is made by first providing a starting material comprised of a support web and a layer of expandable polymer particles on the support web. This starting material is fitted as several layers into a generally closed cavity of a mold or shaping shell so as to only partially fill the cavity. Then energy, for instance microwave radiation, is applied to the starting material in the cavity so as to expand or foam the polymer particles such that the starting material generally fills the cavity.

### FIELD OF THE INVENTION

The present invention relates to a molding method. More particularly this invention concerns a method of molding a laminate or sandwich body.

### BACKGROUND OF THE INVENTION

In order to make a molded article with a sandwich structure having several layers of a foamed polymer substance and separating layers provided between them, it is known to use particles of expandable polymers such as expandable polystyrene (EPS) or expandable polypropylene (EPP). The polymer particles are foamed in a die, and the particle foam completely fills the cavity of the die, hence assuming the desired shape. The foamed polymer substances are very light and have good load-bearing capacity. However, they are fragile and have little flexural and tensile strength. Up to now, in order to improve the mechanical characteristics, molded articles or elements composed of particle foam have been reinforced by lamination with a substrate made of cardboard, paper or a suitable plastic film.

EP 0669195 describes a method for making a molded article in which a polymer foam is surrounded by a substrate material. A polymer film is used as the substrate material. In so doing, in a first method step, a bonding layer is applied to the substrate material that is shaped such that it forms a cavity. The bonding layer faces the cavity to be filled with foam. The cavity is then filled with a polymer substance, and the polymer substance engages the bonding layer and adheres thereto.

In DE 101 50 678 [US 2004/0247856], a molded article is described that has a core made of plastic particle foam and at least one outer reinforcement layer. The connection between the foamed core and the reinforcement layers is achieved by heating one of the two surfaces of the parts to be connected and subsequent pressing. To improve this weld, a film is introduced between plastic and reinforcement layer. Alternatively, the connection between the plastic foam core and the reinforcement layers is achieved by adhesion.

Moreover, DE 101 29 179 describes a composite material with a sandwich structure having alternating tabular layers made of particle foam and foam films composed of polypropylene, polyethylene or polystyrene. The layers are prefabricated and thermally joined together.

### OBJECTS OF THE INVENTION

It is therefore an object of the present invention to provide an improved method of making a laminated molded body.

Another object is the provision of such an improved method of making a laminated molded body that overcomes the above-given disadvantages, in particular that can be executed in a simple and cost-effective manner aided by the provision and use of a suitable starting material.

A further object is for the molded article to have improved mechanical characteristics with low density and particularly high flexural strength.

### SUMMARY OF THE INVENTION

A molded article is made by first providing a starting material comprised of a support web and a layer of expandable polymer particles on the support web. This starting material is fitted as several layers into a generally closed cavity of a mold or shaping shell so as to only partially fill the cavity. Then energy is applied to the starting material in the cavity so as to expand or foam the polymer particles such that the starting material generally fills the cavity.

The laminate used preferably has according to the invention two support web and an intermediate layer composed of the expandable polymer particles. The expandable polymer particles are adhered to the support web, for which purpose a PSA or hot-melt adhesive is preferably used that softens upon heating and does not inhibit expansion of the polymer particles when the laminate is foamed by application of energy. Upon cooling, the adhesive solidifies again.

The material web can consist of a nonwoven, woven, or knitted fabric or paper. These materials are especially suitable as separating and substrate layers for the expandable polymer particles. During expansion of the polymer particles, they are also able to a certain extent to penetrate into the fibrous and in part textile-like materials, thus achieving very good bond strength. With an open-pore structure, extensive soaking can even be achieved depending on the embodiment, thus realizing a very uniform arrangement of the expandable polymer particles. Since these materials are gas pervious or foraminous, a certain degree of ventilation can also be achieved during expansion of the polymer particles, so larger air bubbles or the like can be prevented. If the expandable polymer particles according to a preferred embodiment are attached to the material web using adhesive, the adhesive can also pass through the pores to a certain extent, thus contributing to an increase in the bond strength on both sides of the material web. In order to achieve particularly good strength, a woven made of tape yarn, for example, can be used as the support web.

Moreover, the material web for the formation of the separating layers of the sandwich structure can be composed of a polymeric monofilm, a multilayer coextrusion film or a laminated composite, and the laminated composite can comprise layers made of different polymers or combinations of polymer films, metal foils, textile layers made of reinforcement fibers, or the like In that case they should be formed with holes to vent gases during polymer foaming.

In the framework of the method according to the invention, a laminate is prepared as a starting material having polymer spheres that have not yet been expanded and are preferably embedded between two support webs. The laminate web takes up little volume and can consequently be cost-effectively stored and transported for further processing at other sites into molded article. Since the expandable polymer particles are encapsulated between the support webs so they are protected during transport and no detachment of the particles occurs. The laminate web can be touched without the responsible personnel coming into contact with the polymer substance that has not yet been foamed.

For further processing, the laminate is placed in a mold and/or a shaping shell. The polymer particles encapsulated between the support web are then foamed by application of energy, and the multilayer arrangement of the laminate completely fills the cavity defined by the mold and/or the shell. Since the laminate web is only foamed in the final application, storage and transport costs can be reduced. At the same time, the method according to the invention enables the production of extremely stable and light molded articles.

The multilayer arrangement of the laminate can be formed by rolling or folding the sandwich or laminate. Through the arrangement of the rolled-up or folded laminate web between two thermally nondeformable half-shells, molded articles can be produced that deviate from simple geometric shapes. The number of layers of the laminate web required depends on the size of the cavity and is selected such that the entire cavity is filled by the expanded laminate after foaming. Upon folding of the laminate web, kinks can also be produced that do not expand during the subsequent foaming of the laminate. As a result, molded articles with hinge joints can be produced.

Another advantageous embodiment of the method makes a provision that the laminate is arranged in several layers in a shell. A tubular film is particularly suitable as a shell. For example, the laminate is rolled up and is inserted into the shell or wrapped with a film that is sealed into a shell by a joint weld. This is followed by the foaming of the polymer particles through application of energy. During foaming, the rolled-up laminate web fills out a cavity that is delimited by the shell. The expansion of the polymer particles is limited by the shell. This results in a hard rod with the measurements of the shell. The foamed laminate web is arranged within the shell in the form of a spiral. The spiral arrangement renders the flexural strength independent from the loading direction provided that the load is applied perpendicularly to the longitudinal axis.

As described above, the final shape of the molded article can be prescribed by the shape of the shell with otherwise free expansion. What is more, a shell can also be used if the expansion occurs between two thermally nondeformable half-shells or a corresponding cavity. For instance, it is possible to use covering films or an extensible shell, which are usually pressed to the wall of the mold during expansion through expansion of the material. As a result, it is possible, for example, to produce an especially high-quality, completely closed surface.

To allow the gas produced to be forced out of the cavity during foaming, the shell is air-permeable. The shell is therefore preferably provided with vent openings, for example holes or slits, through which the gas escapes during foaming. The support web, which forms separating layers within a sandwich-like structure of the molded article, is also preferably provided with openings through which the gas can escape during foaming, insofar as pore openings are not already present in any case.

The application of energy for foaming can be achieved, for example by water vapor or laser irradiation. Application of energy by microwave radiation proves to be especially advantageous.

Foaming by microwave radiation proves especially effective if water is introduced into the laminate and/or between the layers of the multilayer arrangement of the laminate before the polymer particles are foamed by application of energy. According to a preferred embodiment of the method according to the invention, the polymer particles that have not yet been expanded are applied to the film coated with adhesive and then sprayed with water. A second film coated with adhesive is then applied. Alternatively or in addition, water can be introduced between the adjacent layers of the laminate web while the laminate web is being rolled up or folded. During foaming, the water absorbs the microwave energy. This leads to uniform application of energy over the entire cross section of the molded article. Through the rolling-up and/or folding of the laminate web in combination with application of energy through microwave radiation, it is possible to achieve an especially uniform foaming of the polymer particles, resulting in a particularly homogeneous structure of the molded article.

Alternatively or in addition, when the foaming is done by microwave radiation, water can also be introduced in an integrated form. For instance, during manufacture the laminated starting material, it is possible to also apply gels or particles in which water is integrated. For example, particles made of superabsorbent polymer can be introduced into the adhesive. Moreover, the introduction of water or water vapor is also possible immediately during or before foaming.

With water or water vapor as an activation medium, foaming using microwaves offers the advantage that the heating can be limited to about 100° C. with controlled feeding of the microwave energy. As a result, the foam formed can be prevented from collapsing as a result of excessive temperatures, which can happen particularly with EPS. In principle, however, other materials that react to microwave radiation, such as carbon particles, are conceivable.

The laminate used for making the molded article can be fabricated as a continuous web. To manufacture a molded article, a piece having the required length is cut from the web. The piece is rolled or folded and arranged in a die and/or a film envelope. Foaming then is initiated by application of energy.

As described above, the expandable polymer particles are preferably applied to the material web with adhesive. In order to achieve the adhesion of the laminate sections to each other upon rolling or folding of the blanks, the laminate can be coated at least on one side, particularly through spraying, prior to rolling or folding with an adhesive. If the material web is composed of a textile material, a nonwoven or a film provided with openings, the adhesive provided for the attachment of the expandable polymer particles can also pass through these openings and pores, thus adhering adjacent laminate sections. Optionally, a larger quantity of adhesive can also be used than is necessary for the attachment of the foamable polymer particles.

A molded article made using the method according to the invention is characterized by a high level of strength due to its sandwich structure. As a result of the sandwich structure, considerably greater strengths can be attained than with conventional polymer foam articles. The molded article is suitable for use as high-strength construction or load-bearing components, for example for the automobile or construction industry which, while having the same stability, are substantially lighter than plastic parts and have greater strength compared to comparable molded articles composed of particle foam. The molded article made using the method according to the invention can be used alone or as a hybrid component in combination with other materials such as, for example, metals. Light components using a molded article embodied according to the invention can be adhesively joined with other parts, for example by ultrasonic welding. It is also possible to adhesively attach other parts to the molded article through foaming or at least to embed them partially therein.

The characteristics of the molded article can be influenced in different ways. For example, the foam particle size can be varied by the selection of the foamable polymer particles and/or the type of application of energy. Moreover, the quantity of the foamable polymer particles applied to a material web can be altered. This way, the thickness of the laminate and hence the proportion of foam to number of layers can be changed. This results in a direct impact on the mechanical properties. In addition, the strength characteristics are also influenced by the selection of the material web. Depending on the specific application, for example, a rigid support web can be used in order to form highly strong molded articles. Moreover, the molded article can also be provided with a certain degree of elasticity. Finally, the surface characteristics can be adapted to the respective requirements through an additional covering layer in the form of a shell.

### BRIEF DESCRIPTION OF THE DRAWING

The above and other objects, features, and advantages will become more readily apparent from the following description, reference being made to the accompanying drawing in which:

FIG. 1 is a cross section through a laminate web that is used as a starting material for making a molded article according to the invention;

FIG. 2 shows a spiral arrangement of the laminate web within a film shell;

FIG. 3 is a cross section through a molded article that was made by foaming of the arrangement shown in FIG. 2;

FIG. 4 shows a folded laminate web in a die; and

FIG. 5 is a section through the molded article that was formed by foaming of the arrangement shown in FIG. 4, particularly after demolding from the die.

### DETAILED DESCRIPTION

As seen in FIG. 1, a laminate has two outer polymer films 2 and 2′ as substrates and one intermediate layer 3 of expandable polymer particles 3. The films 2 and 2′ are composed, for example, of a monofilm made of polyethylene terephthalate (PET, OPET) or a multilayer laminate, for example made of PET/PE.

To produce the laminate 1, an adhesive layer 4 of a pressure-sensitive adhesive (PSA) is applied to the first polymer film 2. To the polymer film 2 coated with pressure-sensitive adhesive are applied polymer particles 3 that have not yet been expanded, EPS spheres and/or EPP spheres particularly being used as polymer particles. The polymer particles 3 are then sprayed with water and finally covered with the second polymer film 2′ coated with adhesive, so that the polymer particles 3 are embedded between the two adhesive layers 4. Instead of spraying with water, a material can also be added as a mixture in which water is combined. To this end, it is possible to mix appropriate particles into the adhesive. These can be, for example, gels, super-absorbent polymer particles with absorbed water, or the like. In relation to such a method version, spraying with water is omitted, thus eliminating the handling of a wet laminate. The combined water can be stored over long periods of time, so immediate processing is not necessary. The addition of water combined in particles can distribute the water in an especially uniform manner. In the case of heating with microwaves as described below, if such particles are mixed into the adhesive, this also offers the advantage that the heat is generated precisely in the area in which the expandable polymer particles 3 are provided.

As described above, when heating with microwaves, water can be sprayed on beforehand or integrated into particles. Alternatively or in addition, if the outer shell is provided with openings, water vapor can also be sprayed in subsequently, which is to say that the laminate can be watered. The subsequent addition of water or water vapor is also possible in making the molded article in a die 9 as described below.

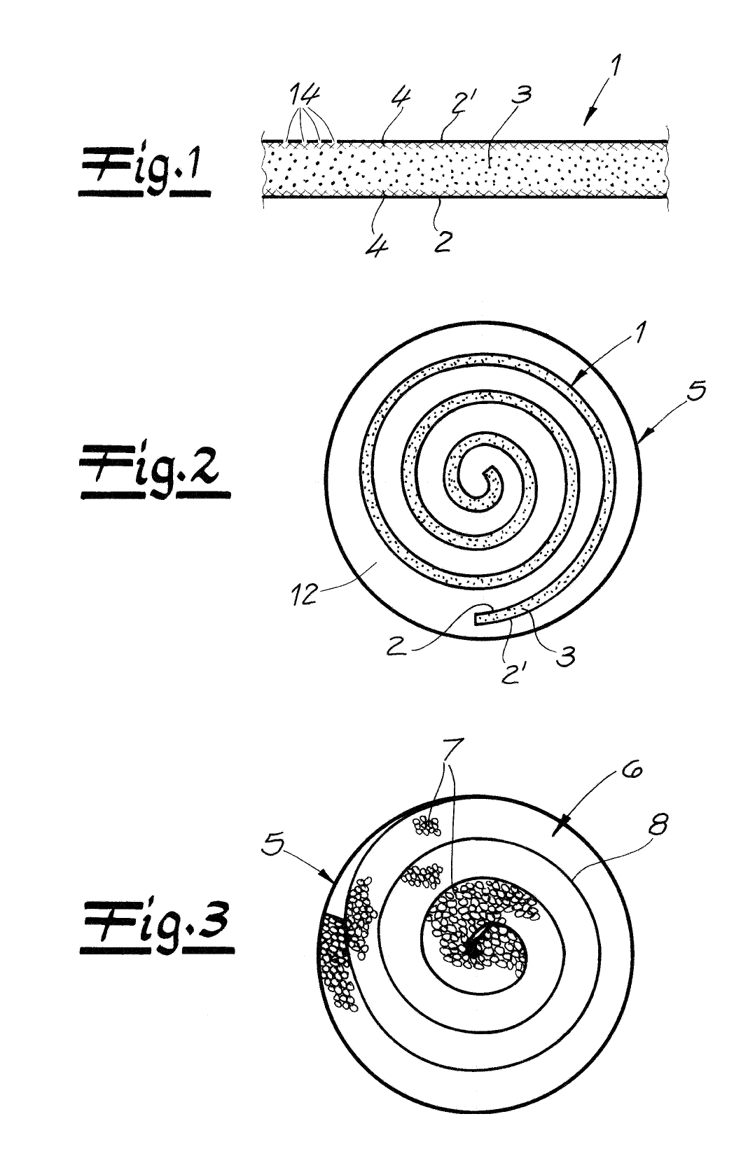

The laminate 1 is rolled up and fitted into a cylindrical shell 5 (FIG. 2). In the sample embodiment, the shell 5 consists of a film and forms a cavity 12 in which the laminate 1 is arranged in multilayered fashion with adjacent turns of the spiral out of contact with each other and with in fact the inner surface of the shell. Each layer of the laminate web is composed of two polymer films 2 and 2′ between which the expandable polymer particles 3 are provided.

In the next method step, the polymer particles 3 are foamed through application of energy. The application of energy occurs in the form of microwave irradiation. The microwave radiation excites the water in the polymer particles 3, resulting in heating and thus the expansion of the polymer particles 3. FIG. 3 shows a cross section through the molded article 6 after the polymer particles 3 of the laminate web 1 rolled up in a spiral were foamed. The molded article 6 has a sandwich structure having several layers 7 composed of a foamed polymer substance and separating layers 8 provided between them. The separating layers 8 are composed of the polymer films 2 and 2′ of the laminate 1. The film shell 5 encloses the sandwich structure of the molded article 6 and forms a shell surface of the molded article. Optionally, the sandwich structure of the molded article 6 can also be adhered to the film shell 5 if an adhesive is applied beforehand to the interface, that is to the outside of the film 2′ or the inside of the cylindrical shell 5. For instance, it is possible to coat one of the films 2 of 2′ of the laminate web with adhesive, thus further increasing the bond strength within the sandwich structure as well.

Both the shell 5 and the polymer films 2 and 2′ have openings 14 shown only in FIG. 1. The holes or openings 14 can be perforations and/or slits through which the gases occurring and expelled during the expansion process escape. when the films 2 and 2′ are a nonwoven textile material or paper, the perforations are usually not necessary.

The polymer films 2 and 2′ within the sandwich structure impart the strength to the finished product. What is more, their spiral arrangement renders the flexural strength independent from the load direction. The density of the molded article 6 and the mechanical characteristics of the molded article 6 can be influenced by the type of polymer films 2 and 2′ that are used as separating layers within the sandwich structure, the materials for the outer shell 5 as well as the quantity of the foamable polymer substance 3.

FIG. 4 shows a die 9 that has a parallelepipedal cavity 13. A laminate 1 is provided in several layers in the cavity of the die 9, folded back over itself and filling somewhat less than half the cavity 13. The laminate 1 has the layered construction illustrated in FIG. 1.

After the laminate 1 is placed in the die 9, the polymer particles 3 of the laminate 1 are foamed by application of energy. The polymer particles 3 expand between the polymer films 2 and 2′ until the cavity of the die 9 is completely filled. Gas formed and expelled during foaming is vented through holes 10 of the die 9. It is also useful for the polymer films 2 and 2′ of the laminate 1 to also have openings (not shown) through which gas can escape during foaming.

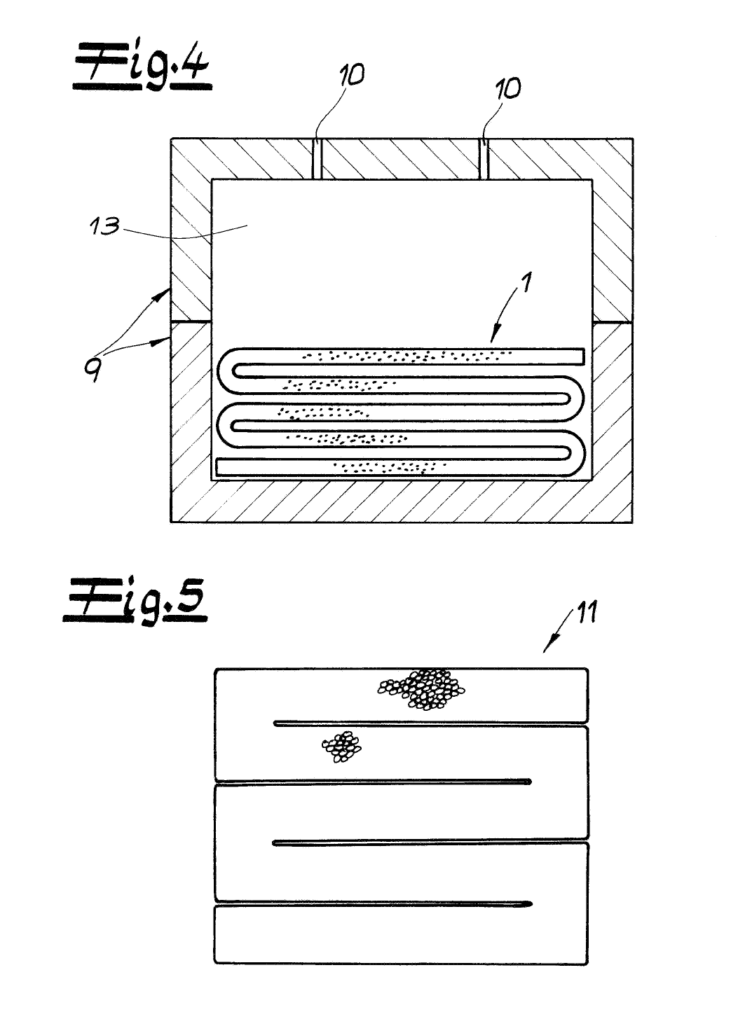

FIG. 5 shows a cross section through the molded article 11 formed according to the described method after it was removed from the die 9. The molded article 11 has a sandwich structure in its cross section that is made up of several layers of the foamed laminate. The individual layers of the sandwich structure adhere tightly to each other and form a composite.

Experimental Results

Table 1 shows the results of the measurement of cylindrical molded articles having the same length, each of which has a diameter of about 22 mm and was supported at its ends in a testing apparatus. What was measured was the maximum bending force absorbed by the test specimens applied to the test specimen in the middle of the rod between the supports transversely to the longitudinal direction of the rod.

The test specimens used in experiments 1 to 4 have a cross section corresponding to the illustration in FIG. 3. The sandwich structure was formed by rolling a film laminate and is surrounded by a film shell. The material of the film shell was varied. Composite materials were used whose layered construction and layer thickness is indicated in Table 1. The laminate used to manufacture the molded article had the laminate construction PET (12 μm)/PSA/EPS/PSA/PET (12 μm).

Experiment 5 is based on a molded article that was foamed using the same laminate in a die but with film envelope.

Experiment 6 refers to a reference experiment on an EPS foam article without sandwich structure with a film envelope formed according to experiment 3.

The experimental results of Table 1 show that molded articles with a sandwich structure according to the invention withstand a considerably higher bending load than an EPS molded article according to the prior art. Moreover, the experimental results in Table 1 show that the use of a film shell additionally increases the stability of the molded article.

TABLE 1

| | | Film Shell | | |
|---|---|---|---|---|
| Experiment | Sandwich | Material | Layer Thickness | |
| No. | Structure | composite | (μm) | Fₘₐₓ[N] |
| 1 | Yes | PET/Alu/PP | 12/8/65 | 138.9 |
| 2 | Yes | PTE/PE | 12/165 | 152.6 |
| 3 | Yes | PET/PE | 12/80 | 130.5 |
| 4 | Yes | PET/PET/PE | 12/12/120 | 149.7 |
| 5 | Yes | No Film Shell | | 105.4 |
| 6 | No | PET/PE | 12/80 | 51.2 |

Experiments 1-5: Sandwich structure through rolled laminate Laminate construction: PET 12 μm/PSA/EPS/PSA/PET 12 μm
Experiment 6: Reference experiment with EPS molded articles without sandwich structure

We claim:

1. A method of making a molded article, the method comprising the step of:
providing a starting material comprised of a support web and a layer of expandable polymer particles on the support web;
fitting the starting material as several layers into a generally closed cavity of a mold or shaping shell so as to only partially fill the cavity; and
applying energy to the starting material in the cavity so as to expand the polymer particles such that the starting material generally fills the cavity.

2. The molding method defined in claim 1, wherein the laminate has two of the support webs that sandwich the layer of expandable polymer particles.

3. The molding method defined in claim 2, further comprising the step of adhering the layer of polymer particles to inner faces of the support webs by respective adhesive layers.

4. The molding method defined in claim 1, wherein the several layers are formed by folding or rolling up the starting material prior to fitting into the cavity.

5. The molding method defined in claim 1, wherein the shell is a tubular film.

6. The molding method defined in claim 1, further comprising the step of:
providing the support web with holes through which gas can move during expansion of the polymer particles.

7. The molding method defined in claim 1, wherein the energy is applied by irradiating the laminate with microwave radiation.

8. The molding method defined in claim 1, further comprising the step of:
providing water in the laminate, whereby the polymer particles are expanded by vaporizing the steam with the applied energy applied.
